(19) United States
(12) Patent Application Publication
(10) Pub. No.: US 2011/0217786 A1
(43) Pub. Date: Sep. 8, 2011

(54) OPTIMIZED TIME TEMPERATURE INDICATOR

(76) Inventors: Chandrasekhar Dayal Mudaliar, Corlim Ihlas Goa (IN); Neelesh Suresh Bahulekar, Markandi (IN); Anil Shanbhag, Mumbai (IN); Suhas Dattatraya Shasrabudhe, Mumbai (IN); Leonhard Feiler, Binzen (DE); Swati Shahsrabudhe, Mumbai (IN)

(21) Appl. No.: 13/098,541

(22) Filed: May 2, 2011

Related U.S. Application Data
(63) Continuation of application No. 12/927,726, filed on Nov. 23, 2010.

(30) Foreign Application Priority Data
Apr. 16, 2008 (EP) 08154635.0

(51) Int. Cl. G01N 21/78

(52) U.S. Cl. 436/92

(57) ABSTRACT

The present invention relates to a time temperature indicator comprising a spiropyran in a colored state and a modifier which is able to control the coloration and decoloration kinetics. The modifier which must be able to form with the spiropyran mixed solids with an amorphous, crystalline or mixed amorphous-crystalline structure.

This application is a continuation of co-pending application Ser. No. 12/927,726, filed on Oct. 14, 2010 which is the National Stage of International Application PCT/EP2009/053948, filed Feb. 4, 2009, the contents of which are herein incorporated by reference.

The present invention relates to a time temperature indicator comprising a photochromic compound in a colored state and a modifier which is able to control the coloration and decolorization kinetics. The invention further relates to the use of a modifier to influence the coloration and decolorization kinetics of a spiropyran pigment.

Colour-changing or colour-forming temperature sensitive indicators for monitoring of handling of perishable goods are well known in the art. Such perishable goods are for example foodstuffs, pharmaceuticals, biological materials, chemical substances, coating compositions, adhesives, cosmetics, food additives, photographic supplies and vaccines. There is a growing interest for indicator systems and devices for monitoring a temperature and a time as an accumulated value of articles, which are stored at a constant temperature for a certain period of time. Such indicator systems are used for signalling when the articles have reached the point of quality loss or unsafe condition due to excessive temperature exposures.

Different classes of dyes are used in time temperature indicators. When irradiated with light of particular wavelengths they change their color reversibly. Due to the supply of energy in the form of light, these dye molecules are converted into state of higher energy, preferably the colored state, which they leave once again when the supply of energy is interrupted, as a result of which they return to their colorless or hardly colored ground state.

The shelf life of perishable goods differs from short periods (e.g. hours or a few days) to quite long periods (e.g. several month). The consequence is that one type of dye is not universally acceptable as time temperature indicator.

The International application WO99/39197 (Ciba) suggests a time temperature indicator comprising a photochromic compound which may be produced both as a solid, for example in the form of glasses or crystals, and in solution. Crystalline indicators show discolouration times of typically one day and longer, amorphous indicators usually show discolouration times of less than one day. By selecting the synthesis conditions or varying the crystal growth processes, the discolouration times can be set specifically.

US 20060068315 describes a color forming composition comprising a spiro dye; and a radiation antenna selected from aluminum quinoline complexes, porphyrins, porphins, indocyanine dyes, phenoxazine derivatives, phthalocyanine dyes, polymethyl indolium dyes, polymethile dyes, guaiazulenyl dyes, croconium dyes, polymethine indolium dyes, metal complex IR dyes, cyanine dyes, squarylium dyes, chalcogenopyryloarylidene dyes, indolizine dyes, pyrylium dyes, quinoid dyes, quinone dyes, azo dyes, and mixtures or derivatives thereof and optionally further comprising a melting aid selected from the group consisting of aromatic hydrocarbons, phenolic ethers, aromatic acid-esters, long chain fatty acid esters with a carbon chain of 6 or greater, polyethylene wax, and derivatives thereof.

The color forming compositions are useful in forming images on optical disks. The document does not address to the problem of influencing the bleaching kinetic of a time temperature indicator.

The aim of the present invention is to find time temperature systems wherein the discoloration time can be adjusted to the shelf life of perishable goods without modifying the substitution pattern of the dye.

It has been found that the addition of a modifier to spiropyrans solves the above mentioned problem.

Thus, the invention relates to a time temperature indicator comprising a spiropyran and a modifier which is able to form with the spiropyran mixed solids with an amorphous, crystalline or mixed amorphous-crystalline structure.

### DEFINITIONS

Spiropyrans consist of a pyran ring linked via a common spirocarbon centre to another heterocyclic ring. Irradiation of the colorless spiropyran with UV light causes heterolytic cleavage of the C—O bond forming the ring-opened colored species.

Suitable spiropyrans are as disclosed in WO05/075978 (Freshpoint), WO08/083,925 (Freshpoint), WO08/090,045 (Freshpoint) and in the European Patent Application EP08156605 (Ciba), filed May 21, 2008.

The international application WO05075978 discloses a TTI comprising a spiropyran derivative of 1′,3′,3′-trimethyl-6-nitro-spiro(2H-1-benzopyran-2,2′-2H-indole) of Formula (III):

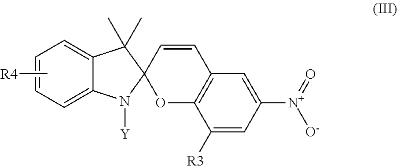

wherein
R3 is selected from the group consisting of H, halogen, C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, or azido; wherein said alkyl, alkenyl, alkynyl, aryl, heteroaryl, and non-aromatic carbocycle may be substituted by one or more group selected from halogen, hydroxyl, thiol, amino, alkoxy, nitro, azido, or sulfo;
R4 is selected from the group consisting of C1-C12 alkyl, C2-C12 alkenyl, C2-C12 alkynyl, C1-C6 alkanoyl, C1-C6 alkoxy, C1-C6 alkylthio, C6-C14 aryl, C4-C14 heteroaryl, C3-C8 membered non-aromatic carbocyclic, C3-C8 membered ring non-aromatic heterocyclic, hydroxyl or —CH═CH—CN; and
Y is selected from C7-C15 aralkyl, wherein said aralkyl may be substituted by one or more group selected from halogen, preferably fluorine.

A particular example of a spiropyran as disclosed in WO05075978 is shown below:

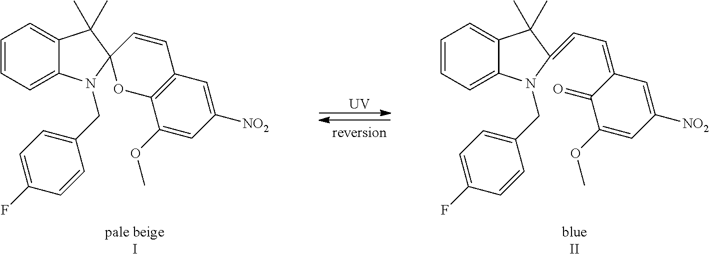

The initially colourless indicator is irradiated with UV light or near-UV light, whereupon the pyran ring of the compound of formula I opens and, the adjacent double bond switches from a cis to a trans configuration producing the isomer II which has an intensive absorption band in the visible region and reverts to compound I after the UV light has been switched off.

The international publication WO08/083,925 discloses a time temperature indicator comprising at least one spiropyran indicator of formula (I)

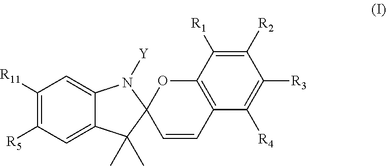

wherein
R₁ is hydrogen, —C₁-C₆ alkoxy, halogen, —C₁-C₆ alkyl or —NO₂;
R₂ is hydrogen or —C₁-C₆ alkoxy;
R₃ is NO₂ or halogen;
R₄ is hydrogen, —C₁-C₆ alkoxy or halogen;
R₅ is hydrogen, halogen, —C₁-C₆ alkoxy, —COOH, —COO—C₁-C₆alkyl, —CF₃ or phenyl;
R₁₁ hydrogen or R₁₁ and R₅ form together a phenyl ring;
Y is phenyl, naphthyl, anthracen-9-yl, 9H-fluoren-9-yl or a residue

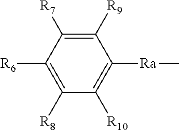

wherein
R₆ is hydrogen, halogen, —C₁-C₆ alkoxy, —NO₂, —CF₃, −O—CF₃, —CN, —COO—C₁-C₆alkyl, phenyl or biphenyl, 9H-fluoren-9-yl;
R₇ is hydrogen, halogen, —CN, —C₁-C₆ alkoxy or R₇ and R₆ form together a phenyl ring;
R₈ is hydrogen, halogen, —CN, or —C₁-C₆ alkoxy;
R₉ is hydrogen or halogen or CN.
R₁₀ is hydrogen or halogen or CN.
Rₐ is —(CH₂)n- with n=1-6 or —CH₂—CH═CH—

A particular example of a spiropyran as disclosed in WO08/083,925 is shown below:

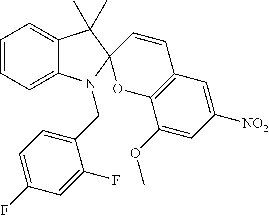

The international publication WO08/090,045 discloses a time temperature indicator comprising at least one dimeric or trimeric spiropyran indicator of the formula I or II

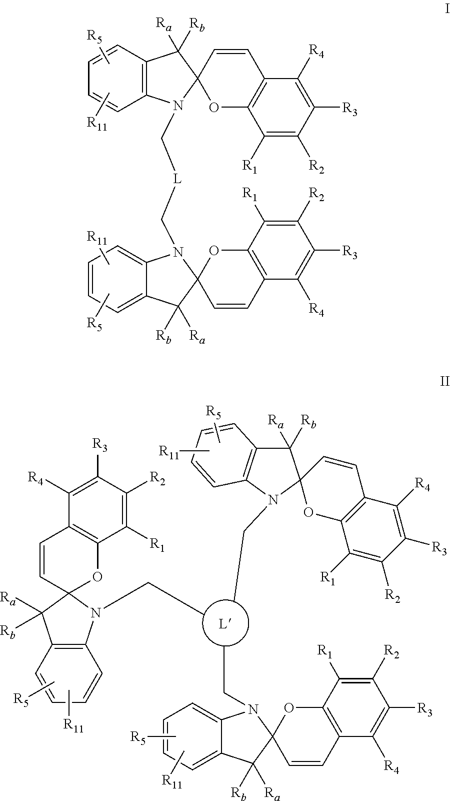

wherein
R₁-R₄ independently of one another is hydrogen, —C₁-C₆ alkoxy, halogen, CF₃, —C₁-C₆ alkyl or —NO₂,
R₅ is hydrogen, halogen, —C₁-C₆ alkoxy, —COOH, —COO—C₁-C₆alkyl, —CF₃ or phenyl;
R₁₁ is hydrogen or R₁₁ and R₅ form together a phenyl ring;
Rₐ is −C₁-C₆ alkyl
R_{b} is —C₁-C₆ alkyl, or together with Rₐ form a 5-6 membered ring
L is a divalent linker;
L′ is a trivalent linker.

A particular example of a spiropyran as disclosed in WO08/090,045 is shown below:

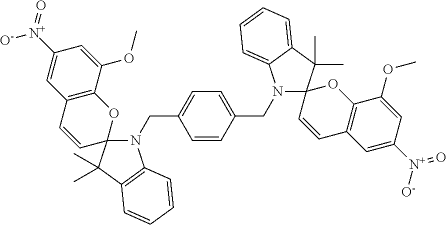

The European patent application EP 08156605, filed Mar. 21, 2008 discloses a time temperature indicator for indicating a temperature change over time, comprising at least one spiropyran indicator of formula (I)

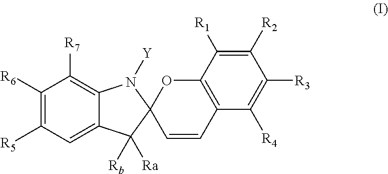

wherein
R₁ is hydrogen, —C₁-C₁₈ alkoxy, halogen, —C₁-C₁₈ alkyl or —NO₂;
R₂ is hydrogen or —C₁-C₁₈ alkoxy;
R₃ is NO₂ or halogen;
R₄ is hydrogen, —C₁-C₁₈ alkoxy or halogen;
R₅ is hydrogen, halogen, —C₁-C₁₈ alkoxy, —COOH, —COO—C₁-C₁₈alkyl, —CF₃ or phenyl;
R₆ is hydrogen or R₆ and R₇ form together a phenyl ring;
R₇ is hydrogen;
Rₐ is hydrogen or —C₁-C₆ alkyl;
R_{b} is hydrogen or —C₁-C₆ alkyl, or together with Rₐ form a 5-6 membered ring;
Y is —CH₂—COO—R₈ or —CH₂—CO—N(R₁₀)—R₉; or —CH₂—CO—N(R₁₀)-L-N(R₁₀) CO—CH₂—;
   wherein
   R₈ is hydrogen, C₁-C₁₈alkyl;
   R₉ is hydrogen, C₁-C₁₈alkyl, phenyl, mesityl, phenyl once or more than once substituted by halogen, —CF₃, C₁-C₆alkyl, —C₁-C₆ alkoxy, carboxy, —COO—C₁-C₆alkyl;
   R₁₀ is hydrogen, C₁-C₁₈alkyl;
   L is 1,3 phenylene or 1,4 phenylene wherein the phenylene linker is optionally substituted by once or more than once by halogen, —CF₃, C₁-C₁₈alkyl, —C₁-C₁₈ alkoxy, carboxy, —COO—C₁-C₁₈alkyl, —CONH₂, —CON(C₁-C₁₈alkyl)₂, nitro; or L is naphthalene, biphenylene or phenylene-O-phenylene wherein the naphthalene, biphenylene or phenylene-O-phenylene linker is optionally substituted once or more than once by halogen, —CF₃, C₁-C₁₈alkyl, —C₁-C₁₈ alkoxy, carboxy, —COO—C₁-C₁₈alkyl, —CONH₂, —CON(C₁-C₁₈alkyl)₂, nitro.

A particular example of a spiropyran as disclosed in EP 08156605 is shown below:

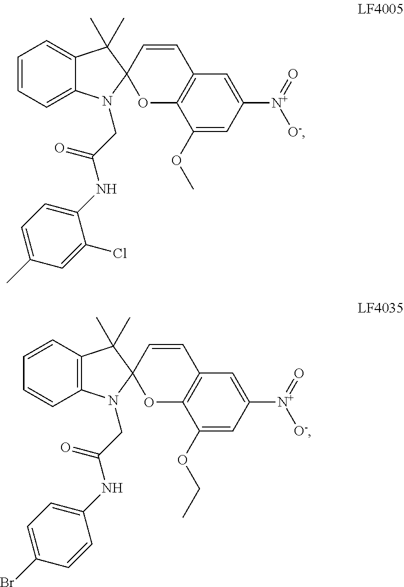

The aim of the present invention is to influence the transfer reverse reaction from the liable high energy state back to the stable ground state, in other words to influence the kinetics in order to adjust the reverse reaction to the shelf life of the perishable goods.

It has been found that the reaction rate of the transfer reverse reaction not only depends on the temperature and on the molecular structure of the dye, but is also a function of polarity of the dye's local microenvironment.

A modifier is any compound which is able to form mixed solids with an amorphous, crystalline or mixed amorphous-crystalline structure.

The mixed solids can be formed by melting, co-melting, co-precipitating out of a solvent, dispersing in a solvent or mechanically by milling.

The modifier must be able to surround the light absorbing compound thus creating a change in polarity of the microenvironment through interaction. These interactions may include electrostatic interactions, van der Waals forces and the like.

Thus the invention relates to a time temperature indicator comprising a spiropyran and a modifier which is able to form with the spiropyran mixed solids with an amorphous, crystalline or mixed amorphous-crystalline structure, whereby the modifier is
selected from esters selected from CH₃—(CH₂)ₙ—COOC₁-C₁₈alkyl with n=10-18; cholesterol oleate; citric acid ester; p-hydroxybenzoate; bornylacetate, or an ester selected from a dicarboxylic acid C₁-C₁₈alkyl-O—OC—(CH₂)ₘ—COOC₁-C₁₈alkyl with m=2-20; or esters selected from sugar alcohols; or the modifier is
selected from a C₆-C₂₀ alkylalcohol; or
selected from a cyclic alcohol; or
selected from a polyalcohol; or
selected from a polyether; or
selected from a fatty acid; or
selected from a salt of a carboxylic acid; or
selected from a diterpene acid; or
selected from urea or imidazole; or
selected from a cyclic ketone; or
selected from 2,6-di-t-butyl-4-methoxyphenol or a 4-hydroxy-3-methoxybenzaldehyd; or
selected from a chroman-6-ole; or
selected from is 4-isopropenyl-1-methylcyclohexen (R-limonene); or
selected from naphthalene, phenanthrene; or
selected from sodium dodecylsulfate; or
selected from a Zn complex of hydroxy naphthoic acid; or
selected from an adduct of a second indolenin unit to the spiropyran; or
selected from a mixed solid of two different spiropyrans.

In any case the modifier is able to control the coloration and decoloration kinetics by influencing the reversible photo induced opening of the pyran ring of the spiropyran. Depending on the kind of modifier the L*, a* or b* values are influenced specifically.

Thus, it is possible to adapt the bleaching behaviour according to the shelf life of the perishable good.

Thus, in one embodiment the time temperature indicator comprises a mixed solid of a spiropyran and naphthalene.

In another embodiment the time temperature indicator comprises a mixed solid of a spiropyran and cetylalcohol.

In another embodiment the time temperature indicator comprises a mixed solid of a spiropyran and sodium dodecylsulfate.

In another embodiment the time temperature indicator comprises mixed solid of a spiropyran and a Zn complex of hydroxy naphthoic acid.

In another embodiment the time temperature indicator comprises a mixed solid of a spiropyran and an adduct of a second indolenin unit to the spiropyran.

In another embodiment the time temperature indicator comprises a mixed solid of two different spiropyrans.

Suitable modifiers further include C8-C30alkylalcohols such as cetylalcohol; salts such as sodium dodecylsulfate, metal complexes such as the Zn complex of hydroxy naphthoic acid.

The modifier can also be a byproduct of the spiropyran synthesis. An example for a byproduct is the adduct of a second indolenin unit to the spiropyran.

The modifier can also be a second spiropyran, for example a mixed crystal of

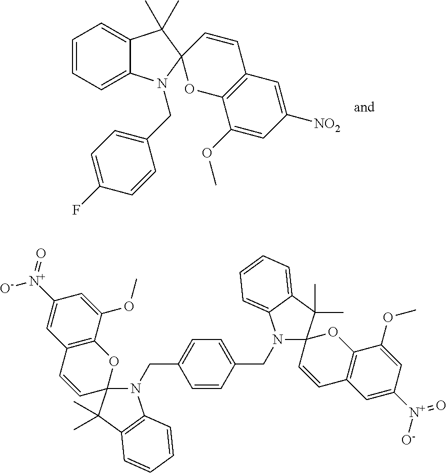

The modifier can also be an ester such as esters selected from CH₃—(CH₂)ₙ—COOC₁-C₁₈alkyl with n=10-18 such as laurylic acid butylester, isopropylmyristate; stearinic acid methylester, or selected from cholesterol oleate, citric acid triethylester, p-hydroxybenzoate (alkylparabene. e.g. methylparabene, butylparabene), o-hydroxybenzoate e.g. salicylic acid alkylester, e.g. salicylic acid methylester, or bornylacetate, or an ester selected from a dicarboxylic acid C₁-C₁₈alkyl-O—OC—(CH₂)ₘ—COOC₁-C₁₈alkyl with m=2-20 such as sebacinic acid dialkylester e.g. sebacinic acid dibutylester.

The modifier can also be an ester of a sugar alcohol such as a sorbitane monooleate or sorbitane monolaurate.

The modifier can also be a long chain C₆-C₂₀ alcohol such as hexadecane-1-ol, octadecane-1-ol, polyethylenemonoalcohol.

The modifier can also be a cyclic alcohol such as 1,7,7-trimethylbicyclo[2.2.1]heptan2-2-ol (borneole) or 1,3,3-trimethylbicyclo[2.2.1]heptan-2-ol (fenchylalcohol).

The modifier can also be an poly alcohol such as glycerol (propane-1,2,3-triol), sorbitol, polycaprolactone diol.

The modifier can also be a polyether such as polyethyleneglycol or polypropyleneglycol, e.g. polyglycol 4000.

The modifier can also be a fatty acid such stearinicacid.

The modifier can also be a salt of a carboxylic acid such as calcium- or magnesium stearate.

The modifier can also be a diterpene acid such as abietic acid.

The modifier can also be urea.

The modifier can also be imidazole.

The modifier can also be a phenol such as 2,6-di-t-butyl-4-methoxyphenol or a 4-hydroxy-3-methoxybenzaldehyd (vanillin)

The modifier can also be a chroman-6-ole (3,4-dihydro-2H-1-benzopyran-6-ole) such as tocopherole (Vit E).

The modifier can also be 4-isopropenyl-1-methylcyclohexen (R-limonene).

The molar ratio of modifier to the spiropyran is >10%, preferably >25.

All the above mentioned modifiers are able to influence the bleaching kinetics.

Therefore the invention further relates to the use of the time temperature indicator as defined in claim 1 to influence the bleaching kinetic of a spiropyrane.

In case the modifier is able to form a melt with the spiropyran the invention further comprises a method to prepare a time temperature indicator comprising the steps of
a) mixing a spiropyran and a modifier,
b) heating the blend obtained under a) to form a melt,
c) cool down the melt obtained under b) to obtain a crystalline or amorph solid, or
d) dissolving the blend obtained under a) in a solvent and crystallisation of the mixture to obtain mixed crystals or mixed solids.

The temperature in step b) is 50-200° C.

The temperature in step c) is preferably 0° C. to room temperature.

The solvent in step d may be an alcohol.

The invention further relates to a method of determining the quality of ageing- and temperature-sensitive products, which comprises the following steps:
a) printing onto a substrate a time-temperature integrator according to claim 1 comprising a spiropyran and a modifier,
b) activation, especially photo-induced coloration, of the indicator by irradiation with UV light,
c) optionally application of a protector which prevents renewed photo-induced coloration of the indicator, and
d) determination of the degree of time- or temperature-induced decoloration and, taking account of the degree of decoloration, the quality of the product.

Suitable substrate materials are both inorganic and organic materials, preferably those known from conventional layer and packaging techniques. There may be mentioned by way of example polymers, glass, metals, paper, cardboard etc.

“Printing” refers to any type of printing such as, relief printing e.g. flexographic printing, pad printing; planographic printing e.g. offset printing or lithographic printing; intaglio printing e.g. gravure printing; screen printing as well as non impact printing process e.g. ink jet printing, pin printing, electrography, thermography, and the like.

Step c) is preferably followed by the application of a protector, especially a colour filter, which prevents renewed photo-induced coloration of the reversible indicator. In the case of UV-sensitive indicators, there come into consideration yellow filters which are permeable only to light having typical wavelengths of more than 430 nm.

The protector may be one as described in PCT Application PCT/EP/2007060987 (Ciba) Thus, the protector may be a transparent colorless or a transparent colored light absorbing protecting layer adhered to the underlying layer of a time temperature indicator characterized in that the light absorbing protecting layer comprises a polymeric binder and 1-50 wt % based on the total weight of the layer of an UV light absorber.

The invention is further explained by the examples.

### EXAMPLE 1

### Spiropyran/Naphthalene as Retarder

5 g (11.9 mmol) finely ground powder of colorless compound of the formula

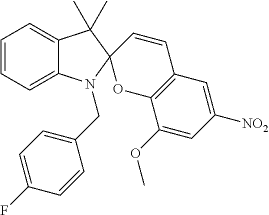

was mixed in the mortar with naphthalene (5.0 g, 39 mmol) and finely powdered. At 60-70° C. the dye and naphthalene melted to form a green solution which was cooled to room temperature. The solidified mixture was then powdered and ink formulations were made with the resultant mixture.

The spiropyran/naphthalene powder was charged for 10 s by an UV lamp

The Table below shows the fading kinetic at 2° C.

| with naphthalene | | | | Comparative, Spiropyran of Ex. 1 | | | | |
|---|---|---|---|---|---|---|---|---|
| (L² + | | | | (L² + | | | | |
| a² + | | | | a² + | | | | Time |
| b²)^{1/2} | L* | a* | b* | b²)^{1/2} | L* | a* | b* | (days) |

| | | | | | | | | |
|---|---|---|---|---|---|---|---|---|
| 56.3 | 31.0 | 5.2 | −46.7 | 55.1 | 38.8 | −1.0 | −39.1 | 0 |
| 56.6 | 39.1 | 5.7 | −40.5 | 56.8 | 47.0 | 1.1 | −31.9 | 0.1 |
| 57.2 | 43.2 | 5.4 | −37.3 | 57.9 | 50.4 | 1.2 | −28.4 | 0.2 |
| 59.9 | 51.7 | 5.1 | −29.7 | 61.1 | 56.3 | 1.6 | −22.2 | 0.8 |
| 59.3 | 51.2 | 4.7 | −29.5 | 60.7 | 56.8 | 1.3 | −21.5 | 1.0 |
| 61.5 | 55.8 | 4.1 | −25.4 | 63.5 | 61.1 | 1.0 | −17.4 | 2.0 |
| 64.5 | 61.3 | 3.4 | −20.0 | 67.2 | 66.3 | 0.6 | −11.5 | 5.0 |

The Table shows that naphthalene modifies the decoloration kinetic.

The L*-value is smaller for the spiropyran/naphthalene system (31.0 compared to 38.8). The increase of the L* value is comparable.

The a* value is nearly constant for the spiropyran alone and is slightly decreasing for the spiropyran/naphthalene system.

The b* value is more quickly increasing for the spiropyran/naphthalene system.

### EXAMPLE 2

### Spiropyran/Sodium Dodecylsulfate as Retarder

5 g finely ground powder of colorless compound of the formula

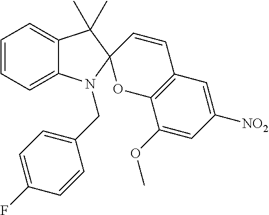

was thoroughly powdered with 5.0 g (17.33 mmol) of sodium dodecyl sulfate (SDS) in a mortar and then the mixture was heated to 60-70° C. with constant stirring when the dye started melting and forming a mixture with SDS. The whole process took 10-15 min. The mixture was then cooled to RT and then the solid was powdered and then submitted for the making the water based formulation.

The spiropyran/sodium dodecyl sulfate powder was charged for 5 s by an UV lamp

The Table below shows the fading kinetic at 2° C. The comparative spiropyran was charged for 10 s.

| with sodium | | | | | | | | |
|---|---|---|---|---|---|---|---|---|
| dodecyl sulfate | | | | Comparative, Spiropyran of Ex. 2 | | | | |
| (L² + | | | | (L² + | | | | |
| a² + | | | | a² + | | | | Time |
| b²)^{1/2} | L* | a* | b* | b²)^{1/2} | L* | a* | b* | (days) |
| 56.9 | 21.5 | 15.2 | −50.4 | 55.1 | 38.8 | −1.0 | −39.1 | 0 |
| 57.8 | 30.1 | 14.8 | −47.0 | 56.8 | 47.0 | 1.1 | −31.9 | 0.1 |
| 57.2 | 35.8 | 12.9 | −42.7 | 57.9 | 50.4 | 1.2 | −28.4 | 0.2 |
| 58.2 | 50.1 | 7.9 | −28.4 | 61.1 | 56.3 | 1.6 | −22.2 | 0.8 |
| 59.5 | 52.5 | 8.3 | −26.8 | 60.7 | 56.8 | 1.3 | −21.5 | 1.0 |
| 62.6 | 58.6 | 6.8 | −19.5 | 63.5 | 61.1 | 1.0 | −17.4 | 2.0 |
| 65.8 | 64.1 | 6.5 | −13.2 | 67.2 | 66.3 | 0.6 | −11.5 | 5.0 |

The Table shows that Na dodecylsulfate modifies the decoloration kinetic.

The L*-value is notably smaller for the spiropyran/Na dodecylsulfate system (21.5 compared to 38.8) and is increasing more quickly.

The a* value is nearly constant for the spiropyran alone and is decreasing for the spiropyran/Na dodecylsulfate system.

The b* value is more quickly increasing for the spiropyran/Na dodecylsulfate system.

### EXAMPLE 3

### Spiropyran/Zn Complex of 2-Hydroxy-3-Naphthoic Acid as Retarder

In a typical procedure 5.0 g (11.97 mmol) of spiropyran

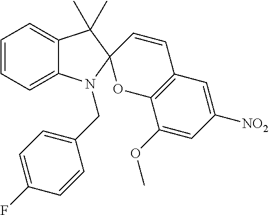

was thoroughly powdered with 5.0 g (11.3 mmol) of Zn complex of 2-hydroxy 3-naphthoic acid in a mortar. A slight red coloration was formed on physical mixing. The mixture was not melted together. The mixture was then submitted for the making the water based formulation.

The spiropyran/Zn complex of 2-hydroxy-3-naphthoic acid powder was charged for 10 s by an UV lamp

The Table below shows the fading kinetic at 2° C.

| with Zn complex | | | | | | | | |
|---|---|---|---|---|---|---|---|---|
| of 2-hydroxy-3- | | | | Comparative spiropyran | | | | |
| naphthoic acid | | | | of Ex. 3 | | | | |
| (L² + | | | | (L² + | | | | |
| a² + | | | | a² + | | | | Time |
| b²)^{1/2} | L* | a* | b* | b²)^{1/2} | L* | a* | b* | (days) |
| 53.2 | 20.0 | 22.0 | −44.1 | 55.1 | 38.8 | −1.0 | −39.1 | 0 |
| 53.5 | 26.9 | 26.4 | −38.0 | 56.8 | 47.0 | 1.1 | −31.9 | 0.1 |
| 53.6 | 29.8 | 27.6 | −35.0 | 57.9 | 50.4 | 1.2 | −28.4 | 0.2 |
| 55.5 | 39.2 | 30.9 | −24.4 | 61.1 | 56.3 | 1.6 | −22.2 | 0.8 |
| 55.7 | 39.7 | 30.6 | −24.3 | 60.7 | 56.8 | 1.3 | −21.5 | 1.0 |
| 57.6 | 43.0 | 32.9 | −19.6 | 63.5 | 61.1 | 1.0 | −17.4 | 2.0 |
| 60.8 | 49.0 | 33.3 | −13.6 | 67.2 | 66.3 | 0.6 | −11.5 | 5.0 |

The Table shows that the Zn complex modifies the decoloration kinetic.

The L*-value is notably smaller for the spiropyran/Zn complex system (20.0 compared to 38.8).

The increase is comparable.

The a* value is high because of the red color of the mixture.

The b* value is slightly smaller for the spiropyran/Zn complex system. The increase of the b value is comparable in both systems.

### EXAMPLE 4

### Spiropyran/Cetylalcohol TTI

5 g (11.97 mmol) finely ground powder of colorless compound of the formula

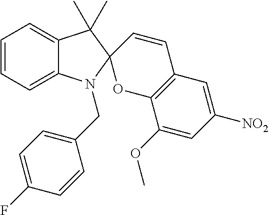

was mixed in the mortar with cetyl alcohol (5.0, 20.62)) and finely powdered. At 60-70° C. the dye and cetylalcohol melted together under constant stirring. The mixture was allowed to cool to room temperature. The solidified mixture was then powdered and ink formulations were made with the resultant mixture.

The spiropyran/cetylalcohol powder was charged for 10 s by an UV lamp

### EXAMPLE 5

The following example shows that the bleaching characteristics are also strongly dependant on the purity of the sample. Depending on the synthesis more or less of a common side product is included in the obtained spiropyran which is proved to be non photochromic. It is more or less an adduct of a second indolenin unit to the spiropyran and has the following general structure:

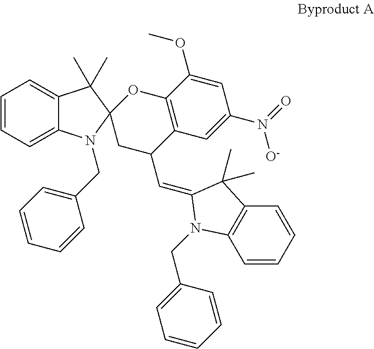

The spiropyran used has the following formula

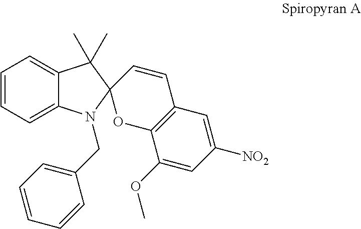

The spiropyran A/Byproduct A (25.5%) powder and the spiropyran A/Byproduct A (5.4%) was charged for 10 s by an UV lamp

The Table below shows the fading kinetic at 2° C.

| spiropyran A/ | | | | spiropyran A/Byproduct A | | | | |
|---|---|---|---|---|---|---|---|---|
| Byproduct A (25.5%) | | | | (5.4%) | | | | |
| (L² + | | | | (L² + | | | | |
| a² + | | | | a² + | | | | Time |
| b²)^{1/2} | L* | a* | b* | b²)^{1/2} | L* | a* | b* | (days) |
| 55.6 | 37.8 | 1.7 | −40.8 | 52.4 | 40.5 | −7.8 | −32.3 | 0 |
| 57.3 | 45.3 | 3.1 | −35.1 | 56.0 | 51.5 | −5.8 | −21.3 | 0.1 |
| 59.1 | 50.3 | 3.8 | −30.7 | — | 53.0 | −5.0 | −17.0 | 0.2 |
| 61.3 | 56.4 | 5.0 | −23.7 | 67.9 | 67.8 | −2.6 | −4.0 | 0.8 |
| 62.2 | 58.1 | 4.8 | −21.9 | 69.4 | 69.4 | −2.0 | −2.1 | 1.0 |
| 63.8 | 61.0 | 4.3 | −18.3 | 72.4 | 72.4 | −1.5 | 1.1 | 2.0 |
| 68.3 | 67.4 | 2.9 | −11.5 | 76.3 | 76.1 | −0.8 | 5.4 | 5.0 |

The Table shows that the L starting value does not depend on the amount of byproduct present. However the bleaching is reduced when the amount of byproduct is higher. Thus the byproduct acts as a retarder.

Spiropyran A/Byproduct A (25.5%) is more reddish (see high a* value)

Spiropyran A/Byproduct A (5.4%) is more bluish and changes its color to yellow (see b* values).

### EXAMPLE 6

The following example also shows that the by product may also act as accelerator.

The bleaching rate is higher when more byproduct is present.

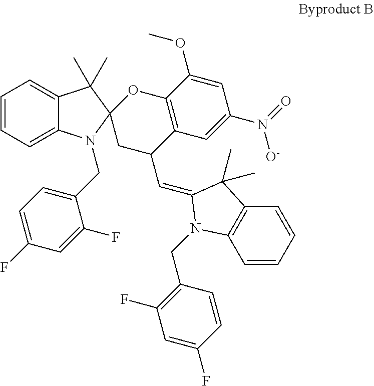

The spiropyran used has the following formula

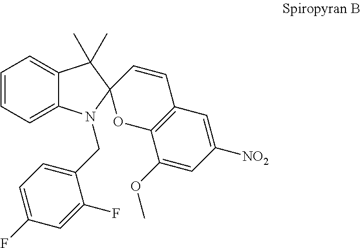

The spiropyran B/Byproduct B (32%) powder and the spiropyran B/Byproduct B (13.6%) powder and the spiropyran B/Byproduct B (0.3%) powder was charged for 10 s by an UV lamp

The Table below shows the fading kinetic at 2° C.

| spiropyran B/ Byproduct B (32%) | | | | spiropyran B/ Byproduct B (13.6%) | | | | Time | spiropyran B/ Byproduct B (0.3%) | | | | Time |
|---|---|---|---|---|---|---|---|---|---|---|---|---|---|
| (L² + a² + b²)^{1/2} | L* | a* | b* | (L² + a² + b²)^{1/2} | L* | a* | b* | (days) | (L² + a² + b²)^{1/2} | L* | a* | b* | (days) |
| 47.5 | 32.3 | −0.9 | −34.8 | 48.5 | 32.4 | 1.2 | −36.2 | 0 | 53.1 | 35.7 | 1.6 | −39.2 | 0 |
| 59.6 | 58.9 | −3.6 | −8.3 | 50.5 | 42.9 | 1.5 | −26.6 | 0.1 | 50.1 | 48.2 | 2.5 | −26.5 | 0.1 |
| 64.1 | 64.1 | −2.8 | −2.5 | 52.5 | 48.2 | 2.6 | −20.8 | 0.2 | 58.3 | 54.0 | 3.6 | −21.9 | 0.2 |
| 69.6 | 69.4 | −1.0 | 5.2 | 59.1 | 58.3 | 3.3 | −8.6 | 1.0 | 62.7 | 61.3 | 3.1 | −13.4 | 1.0 |
| 72.5 | 72.2 | −0.7 | 7.3 | 63.9 | 63.8 | 3.2 | −1.8 | 2.0 | 66.1 | 65.6 | 2.1 | −7.8 | 2.0 |
| 76.7 | 76.0 | −0.1 | 9.6 | 70.0 | 69.7 | 3.0 | 5.4 | 5.0 | 70.7 | 70.7 | 1.6 | −1.4 | 5.0 |

### EXAMPLE 7

The following table lists melt mixes which are based on LF2807 (GSID2074)

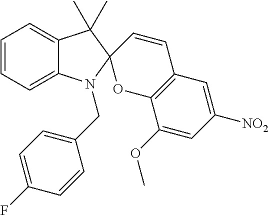

as a basis Spiropyran.

In the first row molten LF2807 is mentioned in 5% loading as a comparison to the compounds mentioned below. These are applied in 10% loading which means a content of 5% Spiropyran in the final print:

| | Mix | Activ. | Colour | | Colour | Eₐ | Time | | Light fastness | | | |
|---|---|---|---|---|---|---|---|---|---|---|---|---|
| Nr | component | time | raw | activ.^{a)} | strength | (kJ/mol) | frame^{b)} | | Charge | Bleach | Result | Comment |
| LF2807^{c)} | — | 1 | bluish | blue | 68.8 | 150 | 4-5 | d | | | | fast bleaching |
| LF3930 | Cholesterin- | 10 | none | blue | 61.4 | 184 | 3 | d | | | | fast bleaching |
| | oleat | | | | | | | | | | | |
| LF3927 | Glycerine | 4 | none | blue | 60.7 | 136 | 4-5 | d | | | | strong |
| | | 10 | none | blue | 64.8 | 155 | 7-8 | d | | | | |
| LF3929 | Abietic acid | 4 | none | blue | 69.9 | 148 | 6-7 | d | | | | strong |
| | | 10 | none | blue | 73.6 | 169 | 6-7 | d | | | | long usability |
| LF3929/2, | | 0.25 | brown | blue | 52.6 | 110 | 5-6 | d | | | | Flexiproof, |
| MM155-1 | | | | | | | | | | | | strong |
| | | 1 | none | blue | 66.6 | 152 | 7 | d | | | | Moser, strong, |
| LF3902 | Citric acid | 4 | none | blue | 61.1 | 150 | 5-6 | d | | | | strong, steady |
| | triethylester | | | | | | | | | | | bleaching |
| | | 10 | none | blue | 67.5 | 141 | 6-7 | d | | | | fast bleaching |
| LF3903 | 2,6-Di-t-butyl- | 4 | bluish | blue | 76.8 | 160 | 8 | d | | | | strong, steady |
| | 4-methoxy- | | | | | | | | | | | bleaching |
| | phenol | 10 | bluish | blue | 72.1 | 174 | 6 | d | strong | strong | low | fast bleaching |
| LF3903/2, | | 4 | grey | blue | 56.9 | 119 | 4-5 | d | slow | strong | low | Moser printed |
| MM153-1 | | 4 | grey | blue | 57.7 | 117 | 6-7 | d | | | | Flexiproof |
| LF4067 | Sorbitan- | 0.4 | bluish | blue | 61.8 | 126 | 5-6 | d | | | | very strong |
| | monooleat | | | | | | | | | | | |
| LF4069 | Tocopherol | 0.4 | bluish | blue | 65.6 | 135 | 5-6 | d | | | | very strong |
| | (Vitamin E) | | | | | | | | | | | |
| LF4063 | Sorbitol | 0.4 | bluish | blue | 59.6 | 138 | 2-3 | d | | | | strong, fast |
| | | | | | | | | | | | | bleaching |
| LF4068 | Methyl- | 1 | bluish | blue | 64.3 | 135 | 4-5 | d | | | | strong, fast |
| | paraben | | | | | | | | | | | bleaching |
| LF4059 | Octadecanol | 1 | bluish | blue | 58.8 | 134 | 4-5 | d | | | | fast bleaching |
| LF4054 | Urea | 0.4 | bluish | blue | 56.5 | 133 | 4-5 | d | | | | see text |
| LF4052 | Butylparaben | 1 | bluish | r. blue | 59.4 | 129 | 3 | d | | | | strong, fast |
| | | | | | | | | | | | | bleaching |
| LF4050 | Borneol | 0.4 | bluish | r. blue | 58.5 | 137 | 3 | d | | | | fast bleaching |
| LF4058 | Isophoron | 10 | none | blue | 59.1 | 146 | 5 | d | n.d. | slow | <B | fast bleaching |
| LF4055 | Calzium- | 10 | none | blue | 61.8 | 136 | 5-6 | d | medium | medium | <B | fast bleaching |
| | stearat | | | | | | | | | | | |
| LF4065 | Isopropyl- | 10 | none | blue | 53.7 | 147 | 5 | d | slow | strong | low | very fast |
| | myristat | | | | | | | | | | | bleaching |
| LF4062 | Salicylic acid | 10 | none | blue | 53.3 | 150 | 4-5 | d | strong | strong | low | |
| | methylester | | | | | | | | | | | |
| LF4064 | Vanillin | 10 | violet | blue | 42.5 | 117 | 2 | d | slow | medium | <B | see text, weak |
| LF4061 | Magnesium | 2 | none | blue | 71.7 | 152 | 5 | d | | | | fast and steady |
| | stearat | | | | | | | | | | | bleaching |
| LF4057 | Fenchol | 0.6 | sl. violet | blue | 61.2 | 117 | 5-6 | d | | | | strong, fast and |
| | | | | | | | | | | | | steady |
| | | | | | | | | | | | | bleaching |
| LF4053 | Laurylic acid | 10 | none | blue | 55.1 | 157 | 6 | d | medium | strong | <<B | weak |
| | butylester | | | | | | | | | | | |
| LF4060 | R-Limonene | 10 | none | bluish | 41.7 | 117 | 3-4 | d | slow | strong | <B | weak, fast |
| | | | | | | | | | | | | bleaching |

^{a)}Colour strength after UV activation
^{b)}at 2° C.
^{c)}Compound molten before ink production

As can be seen above a whole range of melt mixes were performed with LF2807 all of them in a 1:1 ration and performed at 150° C.

Generally the colour of the melt mixes in charged state are in the same range as molten LF2807, in the reddish blue area. Colour strength, bleaching speed and behaviour and the related usability time frame vary drastically however.

A special case is the usage of Vanillin as melt component in LF4064, which exhibits a low colour strength combined with a strong violet colouration in un-charged state. In this case most probably Vanillin reacts as an Aldehyde with the Spiropyran and forms the known violet Indolenin-Methin dye in equilibrium.

Urea as a melt component does form a two phase system during melting, the formation of co crystals (LF4054) of both compounds is not expected therefore. Therefore the properties of the resulting mixture are very similar to these of molten LF2807 alone.

Most other melt mixes exhibit differences in the kinetics, the first identified most interesting mixes were LF3903 and LF3929 due to their high colour strength and long usability time frame.

### EXAMPLE 8

The following table lists melt mixes which are based on LF3155 (GSID3655)

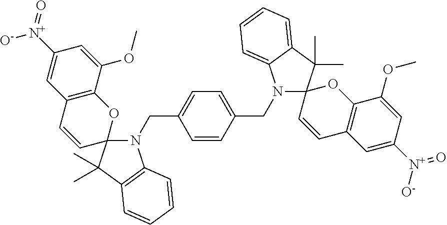

as a basis Spiropyran. In the first row LF3155 is mentioned in 5% loading as a comparison to the compounds mentioned below. These are applied in 10% loading which means a content of 5% Spiropyran in the final print:

| | | Activ. | Colour | | Colour | Eₐ | Time | | Light fastness | | | |
|---|---|---|---|---|---|---|---|---|---|---|---|---|
| Lab-Nr | Mix component | time | raw | activ.^{a)} | strength | (kJ/mol) | frame^{b)} | | Charge | Bleach | Result | Comment |
| LF3155^{c)} | — | 10 | none | blue | 53.1 | 31.6 | 3-4 | d | | | | |
| LF3900 | 2,6-Di-t-butyl-4- | 10 | greyish | blue | 55.7 | 32.7 | 5 | d | | | | 100° C. |
| LF3900, | methoxy-phenol | 10 | none | blue | 46.2 | 37.9 | 6-7 | d | slow | medium | <B | 100° C., weak^{d)} |
| MM151/1 | | | | | | | | | | | | |
| LF3905 | Glycerine | 10 | none | blue | 55.8 | 41.3 | 6-7 | d | | | | 100° C. |
| LF3906 | Biphenyl | 10 | none | blue | 41.4 | 44.9 | 2-3 | d | | | | 100° C., weak |
| LF3908 | Polyethylene- | 10 | none | blue | 57.5 | 50.8 | 5-6 | d | | | | 100° C. |
| LF3908, | monoalcohol | 10 | none | blue | 54.4 | 32.9 | 8-9 | d | very | fast | <B | 160° C.^{d)} |
| MM154/1 | | | | | | | | | slow | | | |
| LF3910 | Cholesterin-oleat | 10 | none | blue | 50.7 | 41.3 | 6 | d | | | | 100° C. |
| | | | | | | | (4° | C.) | | | | |
| LF3911 | Stearinic acid | 10 | none | blue | 49.5 | 48.0 | 4-5 | d | | | | 100° C. |
| LF3901 | Citric acid | 10 | greyish | blue | 55.8 | 42.1 | 4-5 | d | | | | 100° C. |
| | triethylester | | | | | | | | | | | |
| LF3912 | Polycapro- | 10 | none | blue | 44.0 | 43.5 | 2 | d | | | | 100° C., weak |
| | lactone diol | | | | | | | | | | | |
| LF3913 | Abietic acid | 10 | none | blue | 58.1 | 48.1 | 6 | d | | | | 100° C. |
| LF3918 | Stearinic acid | 10 | none | blue | 53.9 | 47.2 | 2-3 | d | | | | 100° C. |
| | methylester | | | | | | | | | | | |
| LF3992 | Methylparaben | 10 | bluish | blue | 41.7 | 40.0 | 5 | d | | | | 190° C. |
| LF3978 | Urea | 10 | greenish | green- | 38.7 | 40.5 | 1-2 | d | | | | 190° C., see text |
| | | | | blue | | | | | | | | |
| LF3976 | Butylparaben | 10 | greyish | blue | 46.3 | 33.6 | 4-5 | d | | | | 190° C. |
| LF3974 | (−)-Borneol | 10 | greyish | blue | 43.7 | 44.7 | 2 | d | slow | slow | <B | 190° C. |
| LF3975 | (−)-Bornyl-acetat | 10 | greyish | blue | 49.5 | 36.5 | 4-5 | d | slow | medium | <B | 190° C. |
| LF3980 | Sebacinic acid- | 10 | greyish | blue | 57.3 | 40.0 | 5-6 | d | very | medium | <B | 190° C. |
| | dibutyl-ester | | | | | | | | slow | | | |
| LF3982 | Isophoron | 10 | none | blue | 48.3 | 41.0 | 4-5 | d | slow | medium | <B | 190° C. |
| LF3986 | Salicylic acid | 10 | none | blue | 49.0 | 37.6 | 4-5 | d | slow | medium | <B | 190° C. |
| | methylester | | | | | | | | | | | |
| LF3987 | Sorbitol | 10 | none | blue | 41.8 | 30.6 | 2-3 | d | very | medium | <B | 190° C. weak |
| | | | | | | | | | slow | | | |
| LF3988 | Vanillin | 10 | violet | blue | 39.6 | 42.0 | 4-5 | d | n.d. | medium | <B | see text |
| LF3907 | Polyglycol 4000 | 10 | none | blue | 45.5 | 38.5 | 2-3 | d | slow | slow | >B | 100° C., weak |
| LF3981 | Fenchol | 10 | none | blue | 46.6 | 34.3 | 2-3 | d | slow | slow | >B | 190° C., weak |
| LF3991 | Sorbitan- | 10 | none | bluish | 28.3 | 27.2 | 1-2 | d | slow | medium | <B | 190° C., weak |
| | monolaurat | | | | | | | | | | | |
| LF3914 | Imidazol | 10 | none | blue | 58.0 | 48.0 | 2 | d | slow | slow | ~B | 100° C. |
| | | | | | | | 5 | d | | | | |
| | | | | | | | (4° | C.) | | | | |

^{a)}Colour strength after UV activation
^{b)}determined at 2° C.
^{c)}Compound measured at 5% loading for comparison
^{d)}The compounds were milled and printed subsequently on the Flexiproof printing press

As can be seen above a whole range of melt mixes were performed with LF3155 all of them in a 1:1 ration and molten at the stated temperature. As can be seen above the colour strength of the compounds could enhanced slightly only in a few cases compared to that in fact mixed crystals or solid solutions were obtained.

LF3155. The kinetics is changed in most cases however, which leads to the conclusion Tocopherol was also used for a melt mix with LF3155. Unfortunately the resulting LF3993 could not be tested in our standard water based ink system due to extreme high viscosity. It was tested in NC and Vinyl inks therefore:

| | Mix | | Colour | | Colour | Eₐ | Time | | Light fastness | | | |
|---|---|---|---|---|---|---|---|---|---|---|---|---|
| Nr | component | Ink | raw | activ.^{a)} | strength | (kJ/mol) | frame^{b)} | | Charge | Bleach | Result | Comment |
| LF3155 | — | Aqu. | none | blue | 53.1 | 133 | 3-4 | d | | | | |
| | | NC | none | blue | 54.5 | 150 | 2 | d | | | | |
| | | Vinyl | beige | blue | 60.9 | 149 | 3 | d | | | | |
| LF3993 | Tocopherol | NC | greyish | blue | 36.9 | 116 | 1-2 | d | none | v. slow | >B | Melt mix at |
| LF3993 | “Vitamin E” | Vinyl | brownish | blue | 49.5 | 141 | 5 | d | slow | fast | <<B | 190° C. |

As can be seen above, the colour strength is on the low side, the Vinyl based print exhibits surprisingly a longer usability time frame due to its nicer bleaching character. In NC the light fastness seems to be higher, but the result has to be confirmed.

### EXAMPLE 9

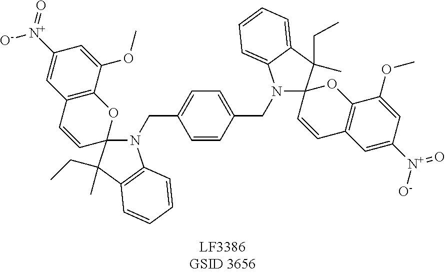

| | | Activ. | Colour | | Colour | Eₐ | Time | Light fastness | | | |
|---|---|---|---|---|---|---|---|---|---|---|---|
| Nr | Mix component | time | raw | activ.^{a)} | strength | (kJ/mol) | frame^{b)} | Charge | Bleach | Result | Comment |
| LF3386/6 | — | 10 | bluish | blue | 55.5 | 151 | 4 d | | | | |
| LF3963 | 2,6-Di-t-butyl-p- | 10 | bluish | blue | 51.4 | n.d. | n.d. | slow | medium | <B | rather weak |
| | methoxy-phenol | | | | | | | | | | |
| LF3965 | Abietic acid | 10 | blue | blue | 35.7 | 170 | 4-5 d | | | | weak |
| LF3964 | Polyethylene- | 10 | bluish | blue | 40.9 | 152 | 3-4 d | slow | slow | ~B | weak |
| | monoalcohol | | | | | | | | | | |

### EXAMPLE 10

Based on LF4005, 1:1

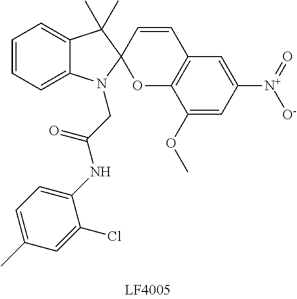

| | | L-Wert | |
|---|---|---|---|
| Lab Nr | Mix component | uncharged | charged 4s |
| LF4121 | 4-Hydroxy-salicylic acid-butylester | 89 | 38 |
| | (Butylparaben) | | |
| LF4122 | 2,6-Di-tert.-butyl-p-kresol | 92 | 44 |
| LF4123 | Stearinic acid | 92 | 55 |
| LF4124 | D-Sorbitol | 91 | 36 |
| LF4125 | Polyethylenglycol 4000 | 90 | 43 |
| LF4126 | 4-Hydroxy-salicylic acid- | 90 | 40 |
| | metylester (Metylparaben) | | |
| LF4127 | Salicylic acid methylester | 89 | 22 |

### EXAMPLE 11

Based on LF4005, 1:1

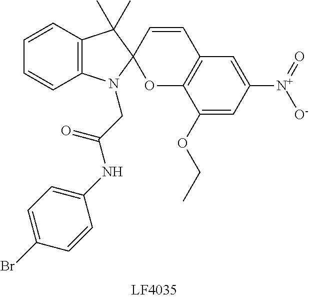

| | | Activ. | Colour | | Colour | Eₐ | Time | Light fastness | | | |
|---|---|---|---|---|---|---|---|---|---|---|---|
| Nr | Mix component | time | raw | activ.^{a)} | strength | (kJ/mol) | frame^{b)} | Charge | Bleach | Result | Comment |
| LF4035 | — | | | | | | | | | | |
| LF4095 | Abietic acid | 10 | colourless | violet | 49.4 | 33.2 | 9-10 | none | strong | medium | low colour |
| | | | | | | | | | | | strength |
| LF4097 | Sodium stearate | 10 | colourless | violet | 23.2 | 31.9 | 3 | not | significant | low | Flexiproof |
| | | | | | | | | tested | | | printed |
| LF4098 | D-Sorbitol | 10 | colourless | violet | 63.9 | 33.9 | 12-13 | slow | medium | medium | nearly linear |
| | | | | | | | | | | | bleaching, |
| LF4099 | Polyglycol 4000 | 4 | colourless | violet | 73.6 | 28.8 | 14-15 | slow | medium | medium | nearly linear |
| | | | | | | | | | | | bleaching, |
| LF4100 | Methylparaben | 10 | colourless | violet | 48.7 | 33.9 | 8 | none | strong | low | |

| | | L-value | |
|---|---|---|---|
| Lab Nr | Mix compponent | uncharged | charged 4s |
| LF4096 | Stearinic acid | 92 | 78 |
| LF4001 | Salicylic acid methylester | 94 | 81 |

1. A time temperature indicator comprising a spiropyran and a modifier which is able to form with the spiropyran mixed solids with an amorphous, crystalline or mixed amorphous-crystalline structure, whereby the modifier is
selected from the group of esters consisting of CH₃—(CH₂)ₙ—COOC₁-C₁₈alkyl with n=10-18; cholesterol oleate; citric acid ester; p-hydroxybenzoate; bornylacetate, dicarboxylic acid C₁-C₁₈alkyl-O—OC—(CH₂)ₘ—COOC₁-C₁₈alkyl with m=2-20; and esters from sugar alcohols;
or the modifier is
a C₆-C₂₀ alkylalcohol;
a cyclic alcohol;
a polyalcohol;
a polyether;
a fatty acid;
a salt of a carboxylic acid;
a diterpene acid; urea or imidazole;
a cyclic ketone;
2,6-di-t-butyl-4-methoxyphenol or a 4-hydroxy-3-methoxybenzaldehyd; a chroman-6-ole;
4-isopropenyl-1-methylcyclohexen (R-limonene);
naphthalene, phenanthrene;
sodium dodecylsulfate;
a Zn complex of hydroxy naphthoic acid;
an adduct of a second indolenin unit to the spiropyran; or
a mixed solid of two different spiropyrans.

2. A time temperature indicator according to claim 1, wherein the modifier is a non polar modifier selected from naphthalene and phenanthrene.

3. A time temperature indicator according to claim 1, comprising a mixed solid of a spiropyran and naphthalene.

4. A time temperature indicator according to claim 1, comprising a mixed solid of a spiropyran and cetylalcohol.

5. A time temperature indicator according to claim 1, comprising a mixed solid of a spiropyran and sodium dodecylsulfate.

6. A time temperature indicator according to claim 1, comprising a mixed solid of a spiropyran and a Zn complex of hydroxy naphthoic acid.

7. A time temperature indicator according to claim 1, comprising a mixed solid of a spiropyran and an adduct of a second indolenin unit to the spiropyran.

8. A time temperature indicator according to claim 1, comprising a mixed solid of two different spiropyrans.

9. A time temperature indicator according to claim 1, wherein the modifier is selected from esters selected from the group consisting of CH₃—(CH₂)ₙ—COOC₁-C₁₈alkyl with n=10-18; cholesterol oleate; citric acid ester; p-hydroxybenzoate; bornylacetate, a dicarboxylic acid C₁-C₁₈alkyl-O—OC—(CH₂)ₘ—COOC₁-C₁₈alkyl with m=2-20; and esters of sugar alcohols.

10. A time temperature indicator according to claim 9, wherein the modifier is selected from the group consisting of laurylic acid butylester, isopropylmyristate, stearinic acid methylester, cholesterol oleate, citric acid triethylester, methylparabene, butylparabene, salicylic acid methylester, bornylacetate and sebacinic acid dibutylester.

11. A time temperature indicator according to claim 1, wherein the modifier is a sugar alcohol.

12. A time temperature indicator according to claim 11, wherein the sugar alcohol is sorbitane monooleate or sorbitane monolaurate.

13. A time temperature indicator according to claim 1, wherein the modifier is a C₆-C₂₀ alcohol.

14. A time temperature indicator according to claim 13, wherein the alcohol is selected from hexadecane-1-ol, octadecane-1-ol and polyethylenemonoalcohol.

15. A time temperature indicator according to claim 1, wherein the modifier is a cyclic alcohol.

16. A time temperature indicator according to claim 15 wherein the cyclic alcohol is 1,7,7-trimethylbicyclo[2.2.1]heptan2-2-ol (borneole) or 1,3,3-trimethylbicyclo[2.2.1]heptan-2-ol (fenchylalcohol).

17. A time temperature indicator according to claim 1, wherein the modifier is a poly alcohol.

18. A time temperature indicator according to claim 17 wherein the poly alcohol is selected from the group consisting of glycerol (propane-1,2,3-triol), sorbitol and polycaprolactone diol.

19. A time temperature indicator according to claim 1, wherein the modifier is a polyether.

20. A time temperature indicator according to claim 19, wherein the polyether is selected from the group consisting of polyethyleneglycol, polypropyleneglycol and polyglycol 4000.

21. A time temperature indicator according to claim 1, wherein the modifier is a fatty acid.

22. A time temperature indicator according to claim 1, wherein the modifier is a salt of a carboxylic acid.

23. A time temperature indicator according to claim 1, wherein the modifier is a diterpene acid.

24. A time temperature indicator according to claim 1, wherein the modifier is urea or imidazole.

25. A time temperature indicator according to claim 1, wherein the modifier is 2,6-di-t-butyl-4-methoxyphenol or 4-hydroxy-3-methoxybenzaldehyd (vanillin)

26. A time temperature indicator according to claim 1, wherein the modifier is tocopherole (Vit E) or R-limonene.

27. A time temperature indicator according to claim 1, wherein the molar ratio of modifier to the spiropyran is >10%.

28. A method of determining the quality of ageing- and temperature-sensitive products, which comprises the following steps:
a) printing onto a substrate a time-temperature integrator according to claim 1 comprising a spiropyran and a modifier,
b) activation of the indicator by irradiation with UV light,
c) optionally application of a protector which prevents renewed photo-induced coloration of the indicator, and
d) determination of the degree of time- or temperature-induced decoloration and, taking account of the degree of decoloration, the quality of the product.
